(19) United States
(12) Patent Application Publication
(10) Pub. No.: US 2025/0335405 A1
(43) Pub. Date: Oct. 30, 2025

(54) METHOD OF PROCESSING MOTION CAPTURE DATA

(71) Applicant: Mi Hiepa Scout Limited, Manchester (GB)

(72) Inventors: John COLES, Ramsbottom (GB); Andrew ETCHES, Stockport (GB); Gareth THATCHER, Altrincham (GB)

(21) Appl. No.: 18/647,724

(22) Filed: Apr. 26, 2024

(51) Int. Cl. G06F 16/215; G06F 16/23; G06T 7/246; G06T 13/40

(52) U.S. Cl. CPC G06F 16/215; G06F 16/2365; G06T 7/246; G06T 13/40; G06T 2207/10016; G06T 2207/10028; G06T 2207/30196

(57) ABSTRACT

A computer implemented method is provided. The computer implemented method comprises receiving motion capture data comprising a plurality of data points representing the positions of one or more objects over a period of time; cleaning the motion capture data so as to ensure the consistency of the cleaned motion capture data with a physical constraint; converting the cleaned motion capture data into a relational format; and outputting the converted motion capture data. A corresponding method of reconstructing an event from motion capture data, a non-transitory computer-readable medium, and a computer system are also provided.

### TECHNICAL FIELD

The present invention relates to methods for processing motion capture data. A corresponding non-transitory computer-readable medium and computer system are also provided.

### BACKGROUND

Motion capture data can be obtained using a number of techniques, including using optical cameras to record motion capture data by recording a series of images of an object in motion. Using recorded motion capture data, the motion of objects represented in the motion capture data can then be recreated and manipulated. For example, a virtual camera can be positioned and the recorded events can be viewed from this virtual camera position, even if no visual data was actually recorded from this position.

However, a folder comprising recorded motion capture data of an event, such as a sports match, is typically of a large size which can prohibit uses of the data (e.g., where there is insufficient network bandwidth to transfer the data at a desired rate). Furthermore, recorded motion capture data may comprise erroneous data points and artefacts in the data that can degrade the usability of the recorded motion capture data.

### SUMMARY OF INVENTION

The invention is defined in the independent claims. Embodiments of the invention are set out in the dependent claims.

According to a first aspect of the disclosure, a computer implemented method is provided. The method comprises receiving motion capture data comprising a plurality of data points representing the positions of one or more objects over a period of time; cleaning the motion capture data so as to ensure the consistency of the cleaned motion capture data with a physical constraint; converting the cleaned motion capture data into a relational format; and outputting the converted motion capture data.

Processing motion capture data in this manner can greatly improve the usability of the motion capture data by removing or decreasing the number of erroneous data points and reducing the size of the output folder comprising the converted motion capture data. In particular, cleaning the motion capture data can remove or replace incorrect data points helping to reduce waste within the file (incorrect data points being wasted file space) and increase accuracy of the recorded motion. Furthermore, converting the cleaned motion capture data into a relational format greatly reduces the size of the resulting data file(s) that are output by utilising the properties of relational formatting of data to avoid unnecessary repetition of data, such as metadata, instead replacing repeated instances of the same information by references to a different location storing that data, such as a metadata file.

Optionally, cleaning the motion capture data comprises identifying one or more objects represented by one or more data points of the motion capture data; identifying a physical constraint associated with the identified objects; determining whether any of the data points representing the identified objects breach the identified physical constraint; and performing one or more cleaning operations on any data points that are determined to breach the identified physical constraint. Optionally, these cleaning steps may be repeated for a plurality of identified physical constraints.

Cleaning the motion capture data by identifying objects represented within the motion capture data by one or more data points, and then identifying physical constraints associated with the identified objects, means that inaccurate data points can be identified and corrected, giving a more accurate and physically realistic output representation of the motion.

Optionally, the one or more cleaning operations comprises, for each data point that breaches the identified physical constraint, deleting the data point, replacing the data point, or adjusting the data point such that the adjusted data point no longer breaches the identified physical constraint. Optionally, when replacing the data point, the data point can be replaced by the corresponding data point from a different frame, preferably an adjacent frame or the closest frame having a corresponding data point that does not breach the identified physical constraint.

Deleting the data point can reduce the size of the motion capture data file(s) by removing data that does not correspond to the actual motion of the objects tracked. Adjusting or replacing the data point improves the accuracy of the data file with respect to the true motion of the object my ensuring the data is consistent with physical constraints and will provide a better output.

Optionally, the identified physical constraint is one of: a length of an object; a size of an object; a shape of an object; a relative position or orientation of two or more objects; and a speed or acceleration of an object.

Utilising one or more of these physical constraints ensures accurate data, for example, by ensuring that the length of a fixed object does not change. These constraints ensure that objects only move in physically realistic ways within the output motion capture data. Different objects may have different constraints, and objects may have multiple different constraints associated with them.

Optionally, determining whether any of the data points representing the identified object breach the identified physical constraint comprises: determining a threshold value associated with the identified physical constraints; and determining whether any of the data points representing the identified object exceed the threshold value.

Utilising a threshold value enables uncertainties in the motion capture or the physical constraints to be reflected in the cleaning, as well as acceptable tolerances of inaccuracies. Larger thresholds may allow data less representative of reality to remain in the converted motion capture data but require less processing power to clean, and vice versa. The thresholds may be set taking into account an appropriate trade off in accuracy and required processing power or latency, depending upon the requirements of a particular use case.

Optionally, the motion capture data comprises a number of frames, and wherein the threshold value is one of: a distance between two data points or an angle formed between three data points within a single frame; and a distance moved by at least one data point equivalent to a threshold translation distance of the identified objects or a threshold rotation of the identified objects between two frames, preferably two consecutive frames.

Utilising threshold values based on a number of data points within a single frame can ensure physical consistency of objects is preserved (e.g., the length of an object does not vary), whilst threshold values based on changes or movements of data points between frames can ensure that objects move in a physically realistic manner (e.g., do not accelerate too quickly).

Optionally, the threshold value is based on at least one of the identified object and the identified physical constraint associated with that object.

In this manner, different objects may have different threshold values, as well as different physical constraints for the same object, reflecting the different required precision and accuracy needed for different objects and use cases.

Optionally, adjusting the data point such that the adjusted data point no longer breaches the identified physical constraints is performed by an artificial intelligence, such as a neural network or machine learning model.

Optionally, identifying the one or more objects represented by one or more data points of the motion capture data is performed by an artificial intelligence, such as a neural network or machine learning model.

Using an artificial intelligence model to adjust the motion capture data or identify objects represented by the motion capture data provides and efficient and adaptable way to perform these tasks. Furthermore, the artificial intelligence models can be updated as more data is obtained, meaning that over time the object identification and adjustment of the data points can become more accurate.

Optionally, identifying a physical constraint associated with the identified object comprises looking up a physical constraint associated with an identified object.

Utilising a look up table of physical constraints associated with different objects is a quick and efficient way of ensuring that key properties of objects are maintained in the data, and that only constraints that are of interest in a particular use case are utilised to minimise the processing overhead of cleaning the data whilst ensuring that the output converted motion capture data is improved.

Optionally, identifying the physical constraint associated with the identified object comprises determining a physical constraint using an artificial intelligence, such as a neural network or machine learning model.

Using an artificial intelligence to identify physical constraints is beneficial when lots of different types of objects or unpredictable objects are present in the motion capture data, that cannot or have not been accounted for in existing rules.

Optionally, cleaning the data comprises removing unnecessary or unwanted data or metadata.

Unnecessary or unwanted data or metadata will depend on the particular use case, and reduces the amount of output converted motion capture data reducing bandwidth requirements.

Optionally, converting the cleaned motion capture data into a relational format comprises extracting metadata into a metadata file, and wherein the method further comprises outputting the metadata file with the converted motion capture data.

Extracting the metadata into a metadata file greatly reduces the unnecessary duplication of metadata and thus reducing the size of the output file(s), while the use of a relational format ensures that the relationship between the extracted metadata and the actual motion capture data points is retained.

Optionally, the motion capture data is divided into a plurality of frames, and wherein extracting metadata into a metadata file comprises extracting metadata consistent across at least some of the plurality of frames into the metadata file.

Optionally, extracting metadata into a metadata file comprises extracting metadata consistent across each of the plurality of frames into the metadata file.

Extracting metadata consistent across some or all of the frames of the motion capture data provides a large reduction in the size of the output converted motion capture data by removing the repetitions of metadata across multiple frames.

Optionally, the motion capture data comprises optical tracking data. Optionally, the motion capture data comprises a point cloud.

Optionally, the one or more objects comprise one or more people, or one or more body parts of one or more people. Optionally, the body parts include any or all of: arms or portions thereof; hands; fingers; legs or portions thereof; feet; torsos; and heads.

Tracking people or body parts of people enables the movement of people, such as players in a sports match, to be reconstructed and viewed from different angles.

Optionally, the one or more objects comprise one or more pieces of equipment. Optionally, the one or more pieces of equipment include one or more balls, bats, rackets, paddles, and cues.

Tracking equipment or other tools or objects enables the movement of objects such as balls to be reconstructed. When combined with tracking people or body parts, it allows people's interactions with objects to be reconstructed.

Optionally, the motion capture data comprises data representing the positions of one or more objects relative to each other, relative to a reference location, or relative to both each other and relative to a reference location.

The particular use case may determine whether it is necessary to track an absolute position of an object (i.e., a position relative to a reference location), whether only the relative position of two or more objects is required, or both.

Optionally, the reference location is a pitch, field, court or other sports area.

Optionally, the converted motion capture data is output in a database. Optionally, the database utilises SQLite, MySQL, or MariaDB.

In this manner, the converted motion capture data can be output in a convenient and accessible relational format enabling easy subsequent use of the data.

Optionally, the received motion capture data is in a text format. Optionally, the text format is JavaScript Object Notation.

Optionally, the converted data is output with one second, half a second, one fifth of a second, one tenth of a second, or one hundredth of a second resolution.

Outputting the converted data is one second resolution (e.g., with one second between consecutive frames) will lead to a relatively small data file (for a given duration of captured data) but with lower resolution, while using one hundredth of a second resolution, for example, will lead to a large file but with high resolution. The use case and network or computing properties will determine the most appropriate resolution for a given use.

Optionally, converting the motion capture data into a relational format includes inserting a file handle at predetermined intervals throughout the motion capture data. Optionally, the predetermined intervals are every minute, every five minutes, or every ten minutes.

Inserting file handles at predetermined intervals enables quick scrolling through the data and seeking of particular points in time.

Optionally, the motion capture data comprises 3D positional data.

Utilising 3D positional data enables a 3D recreation of the captured event which can then be viewed from different angles, including from points of view that do not correspond to the positions of the cameras used to capture the motion capture data.

Optionally, outputting the converted motion capture data comprises sending the converted motion capture data over a network, wherein optionally the network is the internet.

According to a second aspect of the disclosure, a computer implemented method of reconstructing an event from motion capture data is provided. The method comprises receiving output converted motion capture data generated according to the first aspect of the disclosure; and generating a visual representation of the event from the received converted motion capture data.

Utilising the converted motion capture data output by the first aspect of the disclosure to recreate the recorded events by generating a visual representation enables the event to be viewed from different angles to those from which it was actually recorded.

Optionally, the output converted motion capture data is received over a network, wherein optionally the network is the internet.

Optionally, the output converted motion capture data is received over a cellular connection.

Optionally, the motion capture data comprises 3D positional data; and wherein generating a visual representation of the event comprises generating a 3D visual representation of the event.

Utilising 3D positional data enables a 3D recreation of the captured event which can then be viewed from different angles, including from points of view that do not correspond to the positions of the cameras used to capture the motion capture data.

According to a third aspect of the disclosure, a non-transitory computer-readable medium is provided. The non-transitory computer readable medium has stored thereon instructions that, when executed by a computer system comprises one or more processors, cause the computer system to perform the method of the first or second aspects of the disclosure.

According to a fourth aspect of the disclosure, a computer system is provided. The computer system comprises one or more processors and the non-transitory computer readable medium of the third aspect of the disclosure.

### BRIEF DESCRIPTION OF THE DRAWINGS

The invention will be described in more detail with respect to the drawings, of which:

FIG. 1 illustrates a method according to aspects of the disclosure;

FIG. 2 illustrates more detailed steps that may be used to implement portions of the method of FIG. 1;

FIG. 3 illustrates another method according to aspects of the disclosure;

FIG. 4 illustrates received motion capture data;

FIG. 5 illustrates cleaned motion capture data;

FIG. 6A illustrates a visual representation of received motion capture data;

FIG. 6B illustrates a visual representation of cleaned motion capture data;

FIG. 7A illustrates converted motion capture data;

FIG. 7B illustrates a metadata table; and

FIG. 8 illustrates a visual representation of converted motion capture data.

Like or similar features steps will be labelled with the same reference numeral across Figures. It will be appreciated that the Figures are schematic and only for illustrative purposes, and that not every feature or component will necessarily be illustrated in every Figure.

### DETAILED DESCRIPTION OF THE INVENTION

The invention and aspects and embodiments thereof will now be described in detail with reference to the Figures. It will be appreciated that the Figures and description are merely exemplary implementations, and that various modifications and changes may be made by the person skilled in the art.

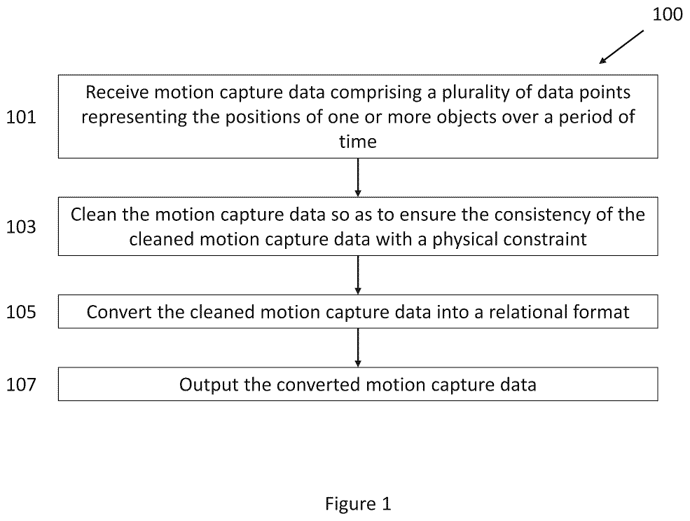

FIG. 1 illustrates a computer implemented method 100. Method 100 begins at step 101 whereby motion capture data is received. The motion capture data comprises a plurality of data points that represent the positions of one or more objects over a period of time. In some implementations, the motion capture data may be received directly from the devices capturing the motion capture data, such as one or more cameras, substantially in real time. However, more generally, the motion capture data may be received over a network such as the internet or via a broadcast or transmission, in substantially real time or otherwise.

The plurality of data points of the motion capture data represent the position objects or parts of objects, relative to some reference point. This may be relative to other objects (e.g., the motion capture data only defines the relative distance between data points) or relative to an external reference. This external reference may correspond to a physical reference area such as a sports pitch or court, but need not necessarily do so. The position of the data points may be defined relative to an arbitrary origin that has no particular physical significance in the real world.

To represent the motion of objects, that is, the positions of objects over a period of time (and how this position changes), the motion capture data consists of data points representing the position of the same object (or part of an object) but at different points in time. Typically, this will be done using frames, with each frame comprising data points representing the position of the tracked objects at a particular point in time and with a time difference between frames. Typically, frames are equally spaced in time, and reflect a frame rate of the system used to capture the motion capture data. For example, in an optical tracking system using cameras capturing images at 60 frames per second, the motion capture data will correspondingly comprise 60 frames per second, but this will not always be the case depending upon how the raw data captured by the motion capture system is processed into the motion capture data, including combining data from multiple sources.

The motion capture data may represent a single object or multiple objects, and each object may be defined in the motion capture data by a number of data points. For example, a ball may be defined by a single data point at each point in time (e.g., each frame), representing the centre of the ball (with other information, such as the size of the ball, existing in a metadata file as discussed later). In another example, a bat may be represented by two data points at each point in time, with each data point defining one end of the bat.

How an object is represented in the motion capture data, such as how many data points are used to capture the position of the object at each time, will vary depending upon the intended use of the converted motion capture data output by the method. If high resolution of the position of an object is desired, then more data points can be used, while for objects for which it is not so important to have as detailed information about the position, fewer data points can be used. For example, a person may be represented by a number of data points at each moment in time, but the exact number used can vary. Considering just the arm of a person, at a relatively basic representation three data points may be used: one representing the position of the top of the arm at the shoulder, one representing the position of the elbow, and one representing the position of the hand. On the other hand, a more detailed representation may further include an additional five data points-one for the tip of each finger and the thumb. Further resolution may be given to the fingers by including yet further data points at the knuckles.

As well as including more data points to capture additional degrees of freedom of an object, such as for additional joints as in the example of fingers above, additional data points can also be included to increase the reliability of the motion capture data by including redundant data points. Taking the example of the bat previously mentioned, while two data points may be, in theory, sufficient to define it by defining the position at each end, if one of these data points is incorrectly measured or recorded then this will give an incorrect position of the bat. If more data points are used, then this can increase the confidence that the position of the bat is correct, particularly once the cleaning of the motion capture data is performed, as discussed further below. For example, if four data points are used to represent the bat, one at each end and two spread along the length of the bat, then if one of the points is incorrect, this can be corrected for in the cleaning step (i.e., a data point not in a straight line with the other three data points can be determined to be incorrect).

Generally speaking, there is no particular limit on what objects can be represented in the motion capture data, provided that the system used to capture the motion capture data is able to register the object to generate the motion capture data. Typical objects include human and animal bodies or parts thereof such as arms, legs, faces and facial expressions, and so on; pieces of equipment and in particular sports equipment such as balls, bats, rackets, and so on; items of apparel and clothes; and vehicles, though it will be understood that this is not an exhaustive list. Often, different types of object will be represented in the motion capture data, such as sports players' bodies and their equipment (rackets and balls, for example).

Returning now to FIG. 1, once the motion capture data has been received at step 101, the method 100 progress to step 103. At this step 103, the motion capture data is cleaned so as to ensure the consistency of the cleaned motion capture data with a physical constraint. This step greatly improves the accuracy and usability of the motion capture data.

All systems and methods of measuring or capturing physical data from the real world will be prone to erroneous readings. Appreciating that certain constraints can be applied to the data, based on real world physical limitations, means that erroneous data points can be identified and accounted for in the motion capture data.

Physical constraints can relate to any physical property of an object, how an object moves, or how an object interacts with other objects that can be represented by or in the motion capture data. One simple physical constraint is that an object known to be rigid and of a fixed length must not bend or change length across the motion capture data. If, in a frame of the motion capture data, an object of a fixed length has changed length (e.g., the distance between data points representing either end of the object has changed from a known length of the object or from previous and/or subsequent frames), it can be determined that at least one of the data points relating to that object is erroneous and appropriate measures can be taken to correct or otherwise minimise the effect of the erroneous data point, as discussed further below.

It will that different physical constraints will apply to different objects depending upon the physical properties of the object. Furthermore, whilst in reality an object may have a certain physical property that could be used to constrain the data points representing that object in the motion capture data, not every possible physical constraint need be applied in each situation. Generally, applying more physical constraints (or stricter physical constraints) will result in a more accurate representation of the object, its movement, and its interactions in the output motion capture data. However, applying more physical constraints will also generally require more processing power to apply and introduce more latency in the system. Therefore, the number of physical constraints applied will be a balance between the accuracy required of the representation of the object and the required latency and available processing power. The physical constraints used can, in particular, be selected depending upon what objects, motions and interactions are most important in a particular use case. For example, in an association football (soccer) match, the representation of players' legs may be more important than their arms. Accordingly, more, or more stringent, constraints may be applied to the data points representing the players' legs compared to the players' arms.

It will be appreciated that while, in FIG. 1, step 105 of converting the cleaned motion capture data into a relational format is performed after step 103 of cleaning the motion capture data, these steps can also be performed in the opposite order. That is, the received motion capture data can be converted to a relational format first and subsequently the converted motion capture data can be cleaned so as to ensure the consistency of the cleaned and converted motion capture data with a physical constraint.

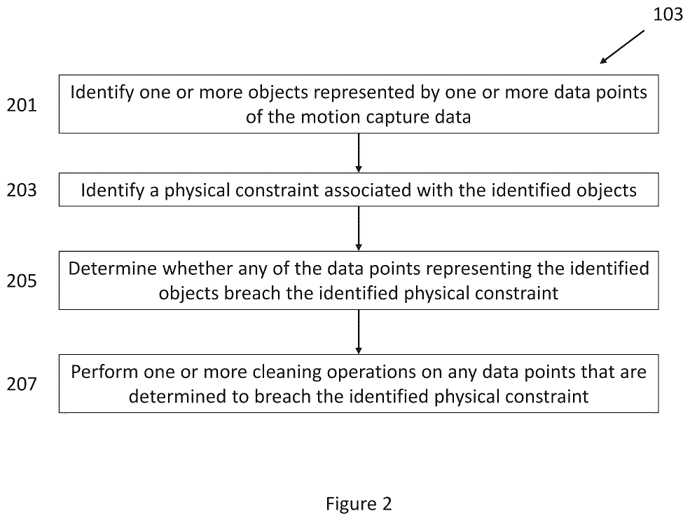

FIG. 2 illustrates a set of steps that can be used to clean the motion capture data during step 103 of method 100.

The first step 201 involves identifying one or more objects represented by one or more data points of the motion capture data. As noted above, different objects will have different physical properties and so have different corresponding physical constraints that could be applied to them. Furthermore, depending upon the use case, it may be desired to apply different subsets of possible physical constraints to different objects, even when those objects have the same potential physical constraints that could be applied.

Identifying objects represented in the motion capture data may comprise reading an object label within the motion capture data itself. Typically, motion capture data provided by dedicated providers of motion capture data for sporting events and the like will include such labels in the provided motion capture data. This approach works well when a known group of objects are being captured in the motion capture data, such as during a sporting event when the objects may be known to comprise, for example, a particular number of players, a referee, and a ball, as in an association football match.

Alternatively, identifying objects represented in the motion capture data may comprise using a computer program to automatically identify objects from otherwise unlabelled motion capture data points. This task may be particularly suitable for artificial intelligence (AI) models, such as neural networks and machine learning models. Based on a set of known objects having representations as data points on which an AI model can be trained, the AI model can then automatically identify, and in some cases label, instances of those objects within the motion capture data. As well, or alternatively, an AI model may not be trained to identify specific objects within the motion capture data, but may be trained to identify generic objects represented in the motion capture data. For example, an AI model may be trained to identify that a particular set of data points move, relative to one another, in such a way that together they likely represent a single object.

It will be appreciated that these techniques are not mutually exclusive, and that any combination of pre-labelled objects, AI identified and labelled objects, and AI identified generic objects may be identified at step 201.

At step 203, a physical constraint associated with the identified objects is identified. Different known types of object may have physical constraints associated with them which can be looked up. As discussed above, it may not be desired to use every possible known physical constraint associated with a particular object, and so identifying physical constraints associated with an object may comprise identifying a particular subset of the physical constraints that are to be used in a particular use case. The physical constraints linked to a particular object may be pre-set by a user (e.g., programmed in), or alternatively may be identified and then pre-set by an artificial intelligence (AI) model, such as a neural network or a machine learning model. Through training on multiple examples of that object within motion capture data, an AI model may be able to determine a set of one or more physical constraints that can be applied to that type of object. Using an AI approach like this may be beneficial in that it determines physical constraints that would not be obvious to a human programmer and may be able to determine a reduced set of physical constraints that can well define an object's physical properties compared to the more physically intuitive physical constraints that a human programmer may use. On the other hand, it may not be apparent exactly what physical properties the AI generated constraints may relate to, and it is important that the AI model is trained on a suitable and varied training set to ensure that the physical constraints do in fact accurately represent the physical properties of the object.

As well as using these pre-set physical constraints, physical constraints may be determined by an AI from within the motion capture data itself. Similarly to how an AI model may be used to identify generic objects as discussed above (i.e., determining that a set of data points represent an object without identifying a particular type of object), an AI model may identify likely physical constraints associated with that object based on how that object has behaved so far in the motion capture data. This can then inform subsequent cleaning of the data in relation to that object.

Once both one or more objects have been identified at step 201 and an associated physical constraint has been identified at step 203, at step 205 it is determined whether any of the data points representing the identified objects breach the identified physical constraints.

Generally, the physical constraints can be split into those that relate to the size, shape or position of an object that can be breached at a particular point in time, and those that relate to movement and acceleration, which may be breached over a period of time.

When looking at physical constraints that relate to a particular point in time (termed “intraframe constraints”), determining whether there is a breach of those physical constraints may involve determining whether the distance between two or more particular data points at a particular point in time (e.g., in a given frame of the motion capture data) is more than a threshold amount larger than a particular value defined by the physical constraint, smaller than a particular value defined by the physical constraint, or differs from a particular value defined by the physical constraint by more than a threshold amount. In particular, this may be how physical constraints relating to stretching or squashing of objects may be monitored.

For other physical constraints relating to the shape of objects, an angle between three particular data points at a particular point in time (e.g., in a given frame of the motion capture data) may be used. For example, it can be determined whether the angle is more than a threshold amount larger than a particular value defined by the physical constraint, smaller than a particular value defined by the physical constraint, or differs from a particular value defined by the physical constraint by more than a threshold amount. To more accurately constrain the shape of an object, both the distance between data points and the angles formed by the data points can be used.

When looking at physical constraints that relate to motion over a period of time (termed “interframe constraints”), the position of the same data point or set of data points at different points in time can be compared (e.g., across different frames). For example, a constraint on the maximum speed of an object may be enforced by looking at the position of a particular data point or set of data points across two different frames and determining a distance moved by the data point or set of data points (e.g., a mean distance moved by each data points in the set, or a distance moved by a centre point of the set of data points, such as a weighted centre point) exceeds a threshold distance over the time period between the two frames, or when the speed of the data point or set of data points is calculated based on the time between the two frames and this exceeds a threshold value. Similarly, a minimum speed can be enforced by determining whether the distance moved in a given time or the speed is less than a threshold value.

An acceleration constraint can also be applied (including both linear acceleration and rotations of objects) by comparing the position of a data point or set of data points over three or more frames. The velocity of an object can be determined between the first and second frames and then between the second and third frames in the manner described above (i.e., determining the speed as described above as well as the direction of the motion), and from this the change in velocity can be determined, giving the acceleration. In some instances, only two frames may be needed to determine acceleration, such as when an initial velocity is known. This may be the case in particular when an object is initially at rest. Therefore, the initial velocity can be assumed to be zero, and a subsequent velocity can be determined by utilising just two frames, and then the acceleration determined accordingly.

Once any data points that breach the identified physical constraint have been determined at step 205, one or more cleaning operations can be performed on the data point(s) that breach the physical constraint at step 207.

Cleaning operations can include any manipulation of the data points in breach of the determined physical constraint so that the resulting motion capture data no longer breaches the determined physical constraint. Particular examples of cleaning operations that may be applied include deleting a data point in breach of a physical constraint, replacing a data point in breach of a physical constraint with another data point, or adjusting a data point in breach of a physical constraint so that it no longer breaches the physical constraint.

Deleting a data point may be an easy way to avoid erroneous data points in particular when there is some redundancy in the information regarding the shape and motion of the object represented by that data point and there are sufficient other data points that do not breach any physical constraints. In this case, the relevant information about the object can still be reconstructed from the remaining data points, and minimal processing power is required.

Alternatively, an erroneous data point can be replaced by a different data point, such as the equivalent data point from a previous or subsequent frame. This may be particularly beneficial when deleting a data point would mean that there would be too little data to accurately represent the object in that frame (e.g., if the erroneous data point was the only data point representing an end of an object, and so without this data point there is no indication of where the end of the object should be). Replacing the erroneous data point with another data point from a similar but different point in time means that a reasonably accurate position of the data point can be provided. The less quickly a data point is moving, the more accurate this approach will be.

As another alternative, an erroneous data point can be adjusted so that it is no longer erroneous. In this case, a new value for the data point is “made up” so that it is within the physical constraints. Preferably, the data point is adjusted as little as possible to satisfy the physical constraint. For example, if the data point is too far away from another data point, adjusting the data point may comprise moving the data point in a straight line toward the other data point until the distance is equal to the threshold distance for that physical constraint. This approach may be particularly beneficial for fast moving objects and their associated data points, where there are large movements of data points between frames and so replacing a data point with one from another frame will lead to a new data point likely to be quite far from the “true” position that data point should be in, and indeed may not lead to the replacement data point meeting the physical constraints either.

These examples of cleaning operations and others may be applied according to a series of rules and priorities. For example, deleting an erroneous data point may be prioritised, but if the data point is defining a maximum extent of an object (e.g., as opposed to further defining an edge between two other data points), replacing the data point with the equivalent data point from the previous frame may be performed, unless this replaced data point would still not meet the physical constraints in which case the erroneous data point may be adjusted until it meets the physical constraints.

Steps 203 to 207 may be repeated any number of times to ensure that an identified object or identified objects comply with multiple physical constraints. For pre-set constraints for a particular object, an order in which the constraints are applied may be set. For example, compliance of the size and shape of an object may be ensured before compliance with any speed and acceleration constraints. In some examples, compliance with intraframe constraints may be ensured first and then compliance with interframe constraints may be ensured. This ordering may be done across all frames as a group, or a subset of frames, e.g., a batch of 10 frames or one minute's worth of motion capture data.

Returning to FIG. 1, once the motion capture data has been cleaned at step 103, such as according to the steps described with reference to FIG. 2, the cleaned motion capture data is converted into a relational format at step 105. Converting the cleaned motion capture data into a relational format involves processing the cleaned motion capture data to convert the data into a structured format, typically in the form of a relational database.

In the received motion capture data, attributes of data points within the motion capture data may be repeated a number of times. This is particularly the case for metadata regarding that data point. In this context, metadata about a data point refers to information regarding the data point other than the positional data of that data point. Metadata may include a name or type of an object that that data point represents (or represents a part of) or other information about the object, such as other data points associated with the data point (e.g., other data points that represent the same object), information about when, where and how the data point was captured, such as a time stamp, a coordinate position, a venue name, sensor hardware specifications, weather and temperature information at the location and time the data point was captured, and so on.

As well as metadata for a particular data point being repeated across at different times in the motion capture data (e.g., across different frames), different data points may also have repeated metadata. For example, every data point captured at a particular time (e.g., within the same frame) may have identical metadata representing the time at which those data points were captured. In some cases, metadata may be repeated across every data point, such as metadata that relates to information about the overall event being captured by the motion capture data, and is referred to as global metadata. Such global metadata may include a venue or location name, a date of the captured event, names teams involved in the event, and so on.

The metadata within the motion capture data can be extracted and stored separately, such as in a metadata file, replaced within the converted motion capture data by references to the metadata within the metadata file. That is, the metadata can be replaced by foreign keys, referencing the metadata in its new location within a dedicated metadata file. This can greatly reduce the amount of repeated metadata and thus can greatly reduce the size of the file or files containing the converted motion capture data, even once the size of the new metadata file is taken into account. In some cases, a single metadata file may be provided to accompany the converted motion capture data, while in other cases multiple metadata files may be provided. For example, for motion capture data covering a long period of time, a separate metadata file may be provided for different sub-periods of the overall period of time. For example, in a sports match comprising two halves, separate metadata files may be provided for each half.

Depending on the use case, some metadata can also simply be deleted, or included in the metadata file as global metadata without including references (e.g., foreign keys) to it in the converted metadata. Global metadata may include metadata that applies to every data point, as discussed above. There may, therefore, be no need to specifically associate each data point with the global metadata as they are implicitly associated through the association of the data points with the metadata file through the references to other pieces of metadata within the metadata file. Whether a particular piece of metadata can be completely discarded (i.e., deleted) will depend on the piece of metadata and the particular use case for the resulting converted motion capture data. Either way, these techniques can further reduce the size of the converted metadata. In some instances, especially where metadata for different periods of time of the motion capture data is divided into multiple metadata files, global metadata may be provided in a separate global metadata file. This means that, if only the events of a later period of the overall event covered by the motion capture data is of interest, the global metadata file and only the metadata files relating to the period of time of interest need be output, reducing how much data need be sent.

Further, another way in which the size of the converted data can be reduced is by reducing the precision of the received data points. Often, the received data points will be encoded with a much higher level of precision than is needed for a typical use case, or that may be justified by the accuracy of the system capturing the motion capture data. Therefore, the data file can be reduced by reducing the precision of the data points without noticeably affecting the end user's experience. For example, a number of decimal points in each data point may be reduced, e.g., from 10 decimal points to 3 decimal points for each data point.

The cleaned motion capture data is typically converted from a text format (e.g., JavaScript Object Notation, JSON) into a relational format in the form of a relational database. The relational database may, for example, by based on SQLite, MySQL, or MariaDB, though this is not an exhaustive list.

Once the motion capture data has been converted into a relational format at step 105, the converted motion capture data is output at step 107. When a metadata file is created during step 105 of converting the motion capture data into a relational format, outputting the converted motion capture data at step 107 also comprises outputting the metadata file with the converted motion capture data as part of outputting the converted motion capture data.

Typically, outputting the converted motion capture data involves transmitting (including broadcasting) the converted motion capture data or sending the converted motion capture data over a network, such as the internet. A particular benefit of converting the motion capture data into a relational format is the reduction in size of the resulting file or files, compared to the originally received motion capture data. This means that sending the converted motion capture data requires less bandwidth, and so the converted motion capture data can be sent over lower bandwidth connections (e.g., cellular networks such as 3G networks) and with lower latency.

When a metadata file is to be sent as part of the outputting of the converted motion capture data at step 107, as described above, the metadata file may be the first piece of data sent. This means that the receiver of the converted motion capture data has the required information to utilise the converted motion capture data when it is subsequently received. It also means that, in the case where only a subset of the time period covered by the motion capture data is of interest, the receiver can selectively request only parts of the motion capture data relating to time periods of interest and then utilise these parts of the motion capture data with reference to the metadata file.

In some cases, the converted motion capture data may be output in real-time, or substantially real-time (i.e., it is output as fast as possible once received, only delayed by the processing time of the intervening method). This may enable the visual representation to be generated (as described below) in real-time, or substantially real-time, provided that the intervening network conditions allow.

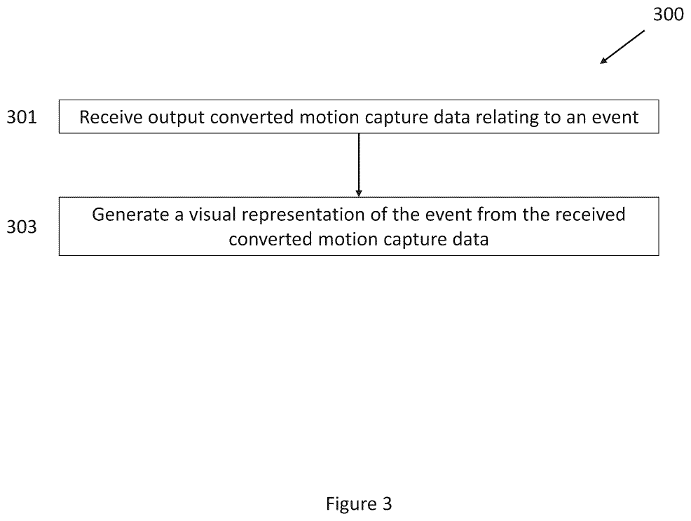

The receiver of the output converted motion capture data may, in particular, utilise the received converted motion capture to reconstruct an event captured by the motion capture data. A method 300 of reconstructing an event from motion capture data is illustrated in FIG. 3.

Method 300 begins at step 301 whereby output converted motion capture data, relating to an event, is received. The output converted motion capture data may be data output according to the method 100 of FIG. 1, for example. The term event in this context is simply used to refer to the movement and interaction of objects, including people, that can be captured as motion capture data. It need not necessarily refer to one specific incidence or interaction, nor an entertainment event, such as a sports match or music performance (though these are encompassed within the term event as used herein).

The output converted motion capture data may be received by any suitable means known in the art, such as by wireless or wired transmission or broadcast. In particular, the output converted motion capture data may be received over a network such as the internet. This may be done, for example, over a cellular network.

Once the output converted motion capture data has been received at step 301, at step 303 a visual representation of the event is generated from the received converted motion capture data. If the motion capture data is 3D motion capture data, the visual representation may be a 3D representation. Alternatively, if the motion capture data is 2D motion capture data, the visual representation may only be a 2D representation. In some cases, despite the motion capture data only being 2D motion capture data, a 3D visual representation may still be generated. For example, where motion of objects represented within the motion capture data is constrained to a plane and where the size and shape of the objects is known, a 3D visual representation can be generated from 2D motion capture data. An example of such a case may be snooker or pool, where the balls are constrained to a plane (the table) and combining the 2D position of the balls on the table with the known sizes and shapes of the balls can enable a 3D visualisation of the balls to be generated.

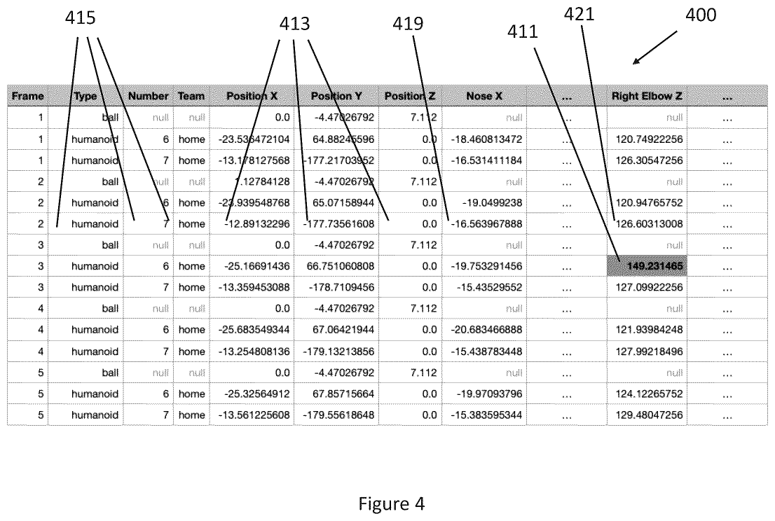

An example of the methods of FIGS. 1 to 3 being implemented will now be described with respect to FIGS. 4 to 7B. The example relates to motion capture data of an association football match, though this should not be considered limiting.

FIG. 4 illustrates a portion of a data file comprising motion capture data 400 relating to the association football match, as may be received at step 101 of method 100. The motion capture data 400 comprises a plurality of data points 413, relating to the position of a particular object or part of an object, as well as associated metadata 415. Metadata 415 is metadata 415 specific to a data point (e.g., a type of the object that data point represents or represents a part of), though global metadata that is the same for all data points may also be included (e.g., a name of the stadium in which the association football match took place). As can be seen in FIG. 4, motion capture data 400 comprises metadata 415 defining the frame to which the data entry relates, and the type of object the entry represents, amongst other information. The plurality of data points 413 comprise x, y and z coordinates of the object, relative to a designated origin, amongst other information.

In this example, each entry (i.e., each row) in the motion capture data 400 relates to a single object which may be defined by multiple individual data points, each of which is specified in the same entry. For example, in FIG. 4, it can be seen that the objects with type “humanoid” have a “Nose X” data point 419, and a “Right Elbow Z” data point 421. Other columns, comprising, for example, the y and z coordinates for the nose data and the x and y coordinates for the right elbow data, along with other data points for other parts of the object have been omitted for clarity, and these missing columns are represented by the ellipses in FIG. 4.

It will be appreciated that in FIG. 4 each row corresponds to one object which may comprise a number of parts tracked in the motion capture data but equally each row may correspond to a single part of an object being tracked. That is, each row may correspond to a single point being tracked and comprise the metadata and position data (e.g., x, y and z coordinates) for that point. For example, the nose of a person may have one row, just comprising the position data for the nose and the associated metadata, while the right elbow may have another row, comprising just the position data for the right elbow and the associated metadata.

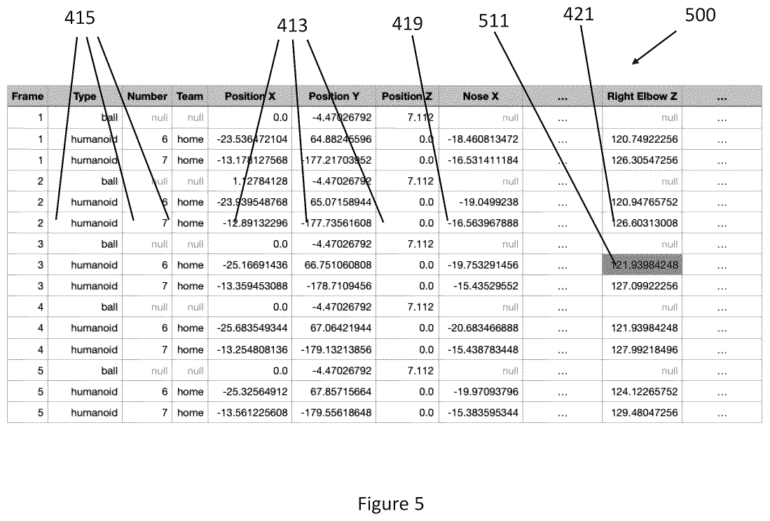

Cleaning the motion capture data 400, at step 103 of method 100, can reveal erroneous data points 411—i.e., data points that breach physical constraints associated with the object to which that data point corresponds. These data points can be cleaned, such as by applying the steps illustrated in FIG. 2 as described above, to create cleaned motion capture data 500, illustrated in FIG. 5.

As can be seen in FIG. 5, cleaned motion capture data 500 comprises the data points 413 and metadata 415 similarly to the (non-cleaned) motion capture data 400. However, erroneous data point 411 has been cleaned. Instead, cleaned motion capture data 500 comprises data point 511.

Data point 511 is an adjusted data point, as described above with resect to step 207 of FIG. 2 and the cleaning operations. In the present example, erroneous data point 411 corresponds to the z coordinate of the right elbow of a player (number 6, as defined in the metadata 415). That erroneous data point 411 is, in fact, erroneous, can be determined by noting that it breaches a physical threshold associated with the right elbow of a player, as described above. One condition that can be applied to the right elbow is that the lengths of the forearm and upper arm are fixed—i.e., they cannot change (more than an acceptable threshold error amount) between frames. The length of the forearm can be determined based on the elbow and wrist position data and simple trigonometric calculations well known to the skilled person, and similarly the length of the upper arm can be determined based on the elbow and shoulder position data. To help determine that it is the z coordinate of the right elbow that is erroneous (as opposed to the x or y coordinate), further information can also be used, such as comparing the coordinate values to the values in the surrounding (e.g., previous or next, which need not be directly adjacent) frames to determine which data point has a value differing too much compared to the value in surrounding frames. This may correspond to a physical threshold relating to a speed or acceleration of an object being limited to a certain threshold value.

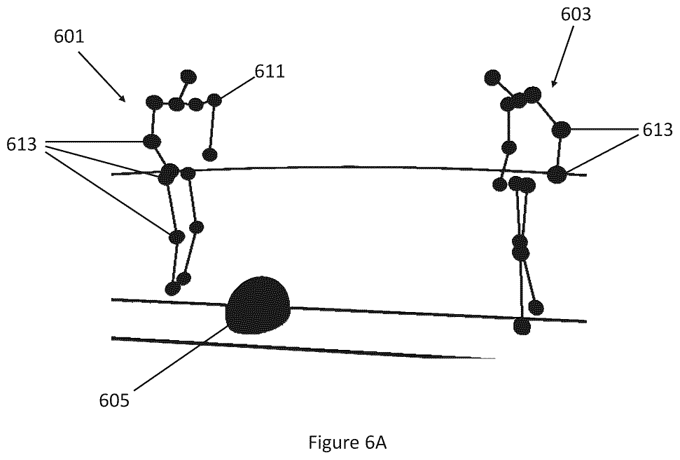

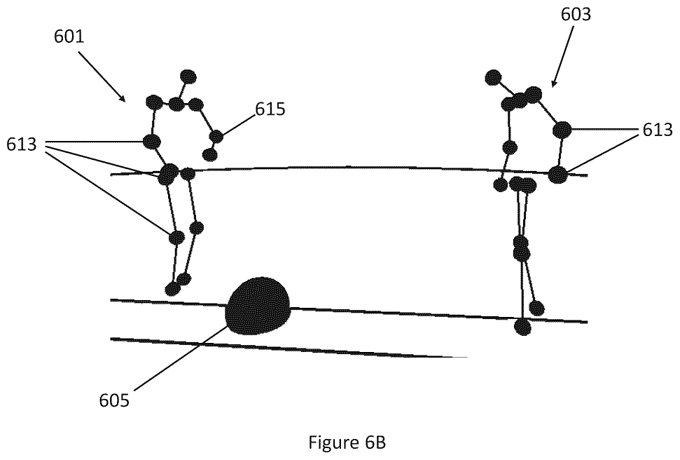

FIGS. 6A and 6B illustrate visual representations of the (non-cleaned) motion capture data 400 and the cleaned motion capture data 500 respectively. These Figures illustrate the improvement to the motion capture data made by cleaning the data in accordance with the methods described herein.

As can be seen, two players 601, 603, (numbers 6 and 7 respectively as specified in the metadata 415), represented in motion capture data 400 are illustrated in FIG. 6A. The ball 605, also represented in the motion capture data 400, is also present.

Each player 601, 603 comprises a plurality of points 613 that are tracked and represented by the motion capture data 413. In the present example, the points being tracked are a head, a left shoulder, a right shoulder, an upper left torso, an upper right torso, a left elbow, a right elbow, a left wrist, a right wrist, a left hip, a right hip, a left knee, a right knee, a left ankle, and a right ankle. These points are just one implementation, and it is equally possible to track additional or alternative points as desired or required by the context.

In FIG. 6A, the right elbow 611 can be seen to be erroneous. The forearm can be seen to be unphysically long while the upper arm is too short, though it will be appreciated that this is a two-dimensional representation of a three-dimensional model. This erroneous point corresponds to erroneous data point 411 in motion capture data 400, as discussed above.

FIG. 6B represents motion capture data 500 comprising corrected data point 511. Again, the two players 601, 603 and the ball 605 are presented in FIG. 6B. All of the points 613 are in the same position as in FIG. 6A, with the exception of point 615 which is a corrected version of erroneous point 611. Corrected point 615 corresponds to corrected data point 511, whereby the z coordinate of the right elbow (the erroneous data point 411) has been corrected so that in FIG. 6B all of the physical constraints are satisfied.

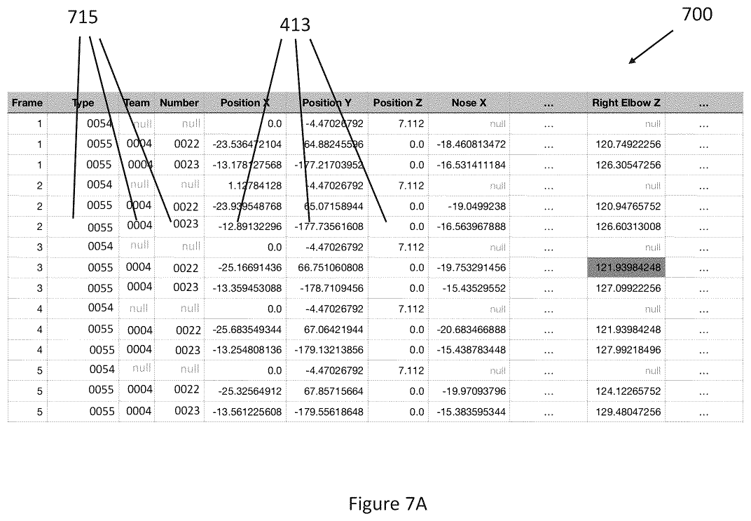

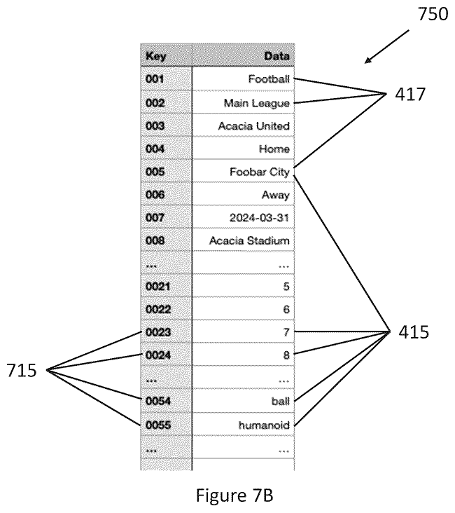

Once the data has been cleaned, method 100 comprises converting the cleaned motion capture data 500 into a relational format at step 105. FIG. 7A illustrates the converted motion capture data 700, while FIG. 7B illustrates a corresponding metadata table 750.

As can be seen in FIG. 7A, converted motion capture data 700 generally corresponds to cleaned motion capture data 500 shown in FIG. 5, comprising motion capture data 413. However, compared to cleaned motion capture data 500, converted motion capture data 700 has had metadata 415 replaced by foreign keys 715. Foreign keys 715 point to corresponding entries in metadata table 750, shown in FIG. 7B.

In FIG. 7B, the metadata table 750 comprises two columns: a column comprising the foreign keys 715 and a column comprising metadata 415, 417. The cleaned motion capture data 500 can be reconstructed from the converted motion capture data 700 and the metadata table 750 by cross-referencing the foreign keys 715. It is also noted that metadata table 750 also comprises global metadata 417, i.e., metadata that is applicable to each entry in the cleaned motion capture data 500, such as the sport and league. Some metadata may be both global metadata 417 and metadata 415 specific to a particular entry. For example, the teams playing (e.g., “Foobar City”, in metadata table 750) are global metadata 417 specifying information about the match that all of the data points 413 relate to, but can also be used as specific metadata 415 to designate to which team a player belongs that data points 413 relate to.

With the cleaned motion capture data 500 converted into a relational form, the converted motion capture data 700 can be output as described with respect to step 107 of method 100. The converted motion capture data 700 can then be received (as per step 301 of method 300) and used to generate a visual representation of the converted motion capture data 700, in accordance with step 303 of method 300.

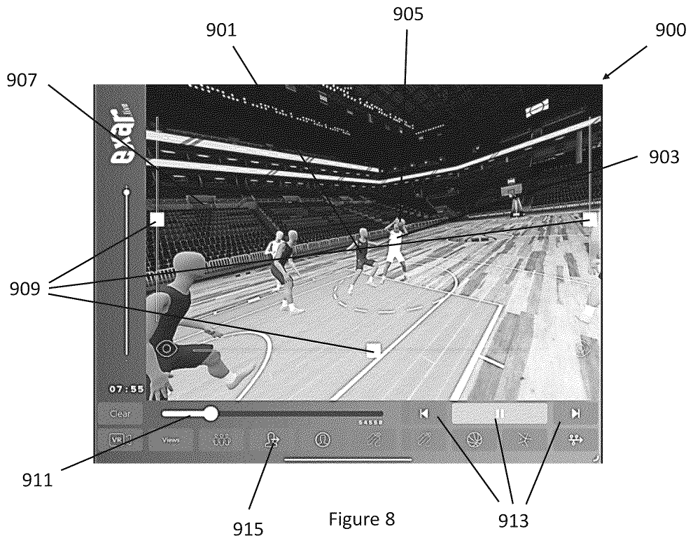

FIG. 8 illustrates a visual representation 900 of converted motion capture data 700. In this example, the received motion capture data 400 related to a basketball match and so converted motion capture data 700 corresponds to the same basketball match. This is now apparent in the visual representation 900, in which it can be seen that the converted motion capture data 700 comprised data points representing objects such as players 901, 903 (and their body parts including arms, hands, legs, feet, torsos, and heads) and a ball 905.

It can be seen how the metadata 415, 417 is used when generating the visual representation 900. For example, players 901 and 903 belong to different teams, as indicated in visual representation 900 by different coloured kits. Each data point in the received motion capture data 400 may comprise metadata 415 information regarding which team that data point “belongs to” (i.e., which team the object or part of an object that data point relates to belongs to), if any. When converting the cleaned motion capture data 500 into a relational format, this metadata 415 can be extracted into metadata table 750 as discussed above. When the visual representation 900 is generated, the references 715 in the converted motion capture data 700 can be used to determine the relevant metadata 415 associated with each data point, and so, in this example, can be used to assign the correct team colours to the players 901, 903.

As previously discussed, metadata 415, 417 can comprise many different pieces of information. Examples relevant to this example include a name of a specific player, the name of the stadium, a score in the match, a time in the match, a name of a match official, and so on.

It will be appreciated that the metadata table 750, in combination with the converted motion capture data 700, need not encode all of the information used to generate the visual representation 900. When generating the visual representation 900, additional information can be accessed or retrieved, typically based on one or more pieces of metadata 415, 417 from the metadata table 750. For example, in the illustrated visual representation 900 of FIG. 8, a visual representation of a stadium 907 has been generated. Because, in the context of a basketball league, there are only a limited number of stadiums that a match may be played in, and because each stadium may require a relatively large amount of data to render, this information may be stored (locally or remotely from the computer system generating the visual representation 900) and accessed based on the metadata 415 indicating the name (or other identifier) of the stadium. In this way, the amount of data required to be output in the converted motion capture data 700 and the metadata table 750 can be reduced. In the context of the present example of a basketball game, this technique could also be used for player appearances, for example.

Because the visual representation 900 is based on the converted motion capture data 700, which in this example is 3D motion capture data, the visual representation 900 can be dynamically interacted with. In particular, the view can be moved to any position or orientation, enabling the match to be viewed from points of view not captured directly by any camera. In another example, “player's eye” views can be implemented, enabling the match to be viewed from the point of view of a specific player.

To assist in interacting with the visual representation 900, a number of tools can be used. It will be appreciated that while some specific implementations of tools are discussed below, these are merely exemplary tools and that others may be used.

Sliders 909 enable the view to be manually adjusted. For example, three sliders 909 can enable movement in the x, y, and z directions. Alternatively, other types of movement may be controlled by the sliders, such as rotation, forward-backward movement, and up-down movement.

Another slider 911 controls the point in time that is currently represented in the visual representation 900. This slider enables scrolling through the converted motion capture data 700 (e.g., between the frames) to enable the position of the objects at a particular point in time to be viewed, and to enable the same event to be viewed from different angles by scrolling backwards and forwards.

Buttons 913 are also provided to control the flow of time in the visual representation 900. Buttons 913 include a play/pause button enabling playback of the converted motion capture data to be paused and resumed. Buttons 913 also include forward and backward skip buttons, causing the visual representation 900 to jump forward and backward respectively a fixed amount in time. In some case, buttons 913 may additionally or alternatively include fast-forward and rewind buttons, enabling playback speed to be modified and reversed.

A number of other controls 915 are also present. These can serve a number of diverse functions to increase the uses of the visual representation 900. Exemplary controls 915 include “player-view” buttons causing the view to switch to a particular player's point of view, “player-focus” buttons causing the view to follow a particular player, “ball-focus” buttons causing the view to follow the ball, buttons that cause the view to be moved to other fixed or moving positions, buttons that cause certain objects to be removed or reincluded in the visual representation (e.g., to enable a user to focus on a particular incident, removing distracting or obfuscating objects), and buttons to add markings or annotations to the visual representation 900. It will be appreciated that this is not an exhaustive list.

While the examples of FIGS. 4 to 8 use an association football match and a basketball game to illustrate the methods described herein, it will be understood that they can be applied in a number of different situations and for a number of different use cases. In particular, it is envisaged that they may be applied to other sports events; entertainment events such as theatrical performances, musical performances, concerts, gigs, and the like; fashion shows and catwalks; and medical uses such as live recreation of surgical procedures or replays of surgical procedures for training, educational, assessment or review purposes. This is not an exhaustive list, and other use cases will be apparent to those skilled in the art.

The methods described herein are computer implemented methods and may be performed by any suitable computer system. Such a computer system may comprise one or more processors, locally arranged or in a distributed or cloud based system, as well as one or more memories to store a computer program encoding the method in a computer-readable format and for storing the data used by the methods (e.g., the different versions of motion capture data and metadata) at the various points in the method. Such memories may include any suitable form of memory, including RAM, hard drives physicals discs such as CDs, solid state drives, and so on. In particular, the memory storing the instructions of the computer program itself may be read-only memory. In order to receive and output data, the computer system may be connected to a network, such as the internet or other local, regional or wide-area networks. This connection may be wired, wireless, or a combination thereof, and the computer system will comprise the appropriate hardware for such a connection, such as antenna for a wireless connection. A computer system configured to generate a visual representation based on the motion capture data may comprise one or more graphics processing units, though this is not essential. The computer system may also comprise outputs including displays in the form of one or more screens or other displays, such as virtual or augmented reality goggles or glasses for outputting the generated visual representation, as well as other outputs such as speakers for playing associated audio.

Aspects of the invention are described below in the following numbered clauses:

Clause 1. A computer implemented method comprising:
receiving motion capture data comprising a plurality of data points representing the positions of one or more objects over a period of time;
cleaning the motion capture data so as to ensure the consistency of the cleaned motion capture data with a physical constraint;
converting the cleaned motion capture data into a relational format; and
outputting the converted motion capture data.

Clause 2. The method of clause 1, wherein cleaning the motion capture data comprises:
identifying one or more objects represented by one or more data points of the motion capture data;
identifying a physical constraint associated with the identified objects;
determining whether any of the data points representing the identified objects breach the identified physical constraint; and
performing one or more cleaning operations on any data points that are determined to breach the identified physical constraint.

Clause 3. The method of clause 2, wherein the one or more cleaning operations comprises, for each data point that breaches the identified physical constraint, deleting the data point, replacing the data point, or adjusting the data point such that the adjusted data point no longer breaches the identified physical constraint.

Clause 4. The method of clause 2 or 3, wherein the identified physical constraint is one of: a length of an object; a size of an object; a shape of an object; a relative position or orientation of two or more objects; and a speed or acceleration of an object.

Clause 5. The method of any of clauses 2 to 4, wherein determining whether any of the data points representing the identified object breach the identified physical constraint comprises:
determining a threshold value associated with the identified physical constraints; and
determining whether any of the data points representing the identified object exceed the threshold value.

Clause 6. The method of clause 5, wherein the motion capture data comprises a number of frames, and wherein the threshold value is one of:
a distance between two data points or an angle formed between three data points within a single frame; and
a distance moved by at least one data point equivalent to a threshold translation distance of the identified objects or a threshold rotation of the identified objects between two frames, preferably two consecutive frames.

Clause 7. The method of clause 5 or 6, wherein the threshold value is based on at least one of the identified object and the identified physical constraint associated with that object.

Clause 8. The method of any of clauses 3 to 7, wherein either of both of:
adjusting the data point such that the adjusted data point no longer breaches the identified physical constraints is performed by an artificial intelligence, such as a neural network or machine learning model; and
wherein identifying the one or more objects represented by the one or more data points of the motion capture data is performed by an artificial intelligence, such as a neural network or machine learning model.

Clause 9. The method of any preceding clause, wherein converting the cleaned motion capture data into a relational format comprises extracting metadata into a metadata file, and wherein the method further comprises outputting the metadata file with the converted motion capture data.

Clause 10. The method of clause 9, wherein the motion capture data is divided into a plurality of frames, and wherein extracting metadata into a metadate file comprises extracting metadata consistent across at least some of the plurality of frames into the metadate file; and
wherein optionally extracting metadata into a metadate file comprises extracting metadata consistent across each of the plurality of frames into the metadate file.

Clause 11. The method of any preceding clause, wherein the motion capture data comprises optical tracking data.

Clause 12. The method of any preceding clause, wherein the motion capture data comprises a point cloud.

Clause 13. The method of any preceding clause, wherein the motion capture data comprises data representing the positions of one or more objects relative to each other, relative to a reference location, or relative to both each other and relative to a reference location.

Clause 14. The method of any preceding clause, wherein the converted motion capture data is output in a database.

Clause 15. The method of any preceding clause wherein the converted data is output with one second resolution.

Clause 16. The method of any preceding clause wherein converting the motion capture data into a relational format includes inserting a file handle at predetermined intervals throughout the motion capture data.

Clause 17. The method of clause 16, wherein the predetermined intervals are every minute, every five minutes, or every ten minutes.

Clause 18. The method of any preceding clause, wherein the motion capture data comprises 3D positional data.

Clause 19. The method of any preceding clause, wherein outputting the converted motion capture data comprises sending the converted motion capture data over a network, wherein optionally the network is the internet.

Clause 20. A computer implemented method of reconstructing an event from motion capture data comprising:
receiving output converted motion capture data generated according to any preceding clause; and
generating a visual representation of the event from the received converted motion capture data.

Clause 21. The method of clause 20, wherein the output converted motion capture data is received over a network, wherein optionally the network is the internet.

Clause 22. The method of clause 20 or 21, wherein the output converted motion capture data is received over a cellular connection.

Clause 23. The method of any of clauses 20 to 22, wherein the motion capture data comprises 3D positional data; and
wherein generating a visual representation of the event comprises generating a 3D visual representation of the event.

Clause 24. A non-transitory computer-readable medium having stored thereon instructions that, when executed by a computer system comprises one or more processors, cause the computer system to perform the method of any preceding clause.

Clause 25. A computer system comprising one or more processors and the non-transitory computer readable medium of clause 24.

1. A computer implemented method comprising:
receiving motion capture data comprising a plurality of data points representing the positions of one or more objects over a period of time;
cleaning the motion capture data so as to ensure the consistency of the cleaned motion capture data with a physical constraint;
converting the cleaned motion capture data into a relational format; and
outputting the converted motion capture data.

2. The method of claim 1, wherein cleaning the motion capture data comprises:
identifying one or more objects represented by one or more data points of the motion capture data;
identifying a physical constraint associated with the identified objects;
determining whether any of the data points representing the identified objects breach the identified physical constraint; and
performing one or more cleaning operations on any data points that are determined to breach the identified physical constraint.

3. The method of claim 2, wherein the one or more cleaning operations comprises, for each data point that breaches the identified physical constraint, deleting the data point, replacing the data point, or adjusting the data point such that the adjusted data point no longer breaches the identified physical constraint.

4. The method of claim 2, wherein the identified physical constraint is one of: a length of an object; a size of an object; a shape of an object; a relative position or orientation of two or more objects; and a speed or acceleration of an object.

5. The method of claim 2, wherein determining whether any of the data points representing the identified object breach the identified physical constraint comprises:
determining a threshold value associated with the identified physical constraints; and
determining whether any of the data points representing the identified object exceed the threshold value.

6. The method of claim 5, wherein the motion capture data comprises a number of frames, and wherein the threshold value is one of:
a distance between two data points or an angle formed between three data points within a single frame; and
a distance moved by at least one data point equivalent to a threshold translation distance of the identified objects or a threshold rotation of the identified objects between two frames, preferably two consecutive frames.

7. The method of claim 5, wherein the threshold value is based on at least one of the identified object and the identified physical constraint associated with that object.

8. The method of claim 3, wherein either of both of:
adjusting the data point such that the adjusted data point no longer breaches the identified physical constraints is performed by an artificial intelligence, such as a neural network or machine learning model; and
wherein identifying the one or more objects represented by the one or more data points of the motion capture data is performed by an artificial intelligence, such as a neural network or machine learning model.

9. The method of claim 1, wherein converting the cleaned motion capture data into a relational format comprises extracting metadata into a metadata file, and wherein the method further comprises outputting the metadata file with the converted motion capture data.

10. The method of claim 9, wherein the motion capture data is divided into a plurality of frames, and wherein extracting metadata into a metadate file comprises extracting metadata consistent across at least some of the plurality of frames into the metadate file; and
wherein optionally extracting metadata into a metadate file comprises extracting metadata consistent across each of the plurality of frames into the metadate file.

11. The method of claim 1, wherein the motion capture data comprises optical tracking data.

12. The method of claim 1, wherein the motion capture data comprises a point cloud.

13. The method of claim 1, wherein the converted motion capture data is output in a database.

14. The method of claim 1, wherein converting the motion capture data into a relational format includes inserting a file handle at predetermined intervals throughout the motion capture data.

15. The method of claim 1, wherein the steps of receiving motion capture data, cleaning the motion capture, converting the cleaned motion capture data into a relational format, and outputting the converted motion capture data are performed at by a first computer system, the method further comprising, at a second computer system:
receiving the output converted motion capture data; and
generating a visual representation of the event from the received converted motion capture data.

16. The method of claim 15, wherein the output converted motion capture data is received over a network, wherein optionally the network is the internet.

17. The method of claim 15, wherein the output converted motion capture data is received over a cellular connection.

18. The method of claim 15, wherein the motion capture data comprises 3D positional data; and
wherein generating a visual representation of the event comprises generating a 3D visual representation of the event.

19. A non-transitory computer-readable medium having stored thereon instructions that, when executed by a computer system comprising one or more processors, cause the computer system to perform a method comprising:
receiving motion capture data comprising a plurality of data points representing the positions of one or more objects over a period of time;
cleaning the motion capture data so as to ensure the consistency of the cleaned motion capture data with a physical constraint;
converting the cleaned motion capture data into a relational format; and
outputting the converted motion capture data.

20. A computer system comprising one or more processors and a non-transitory computer readable medium having stored thereon instructions that, when executed by the one or more processors, cause the computer system to perform a method comprising:
receiving motion capture data comprising a plurality of data points representing the positions of one or more objects over a period of time;
cleaning the motion capture data so as to ensure the consistency of the cleaned motion capture data with a physical constraint;
converting the cleaned motion capture data into a relational format; and
outputting the converted motion capture data.
